(19) United States
(12) Patent Application Publication
(10) Pub. No.: US 2016/0225494 A1
(43) Pub. Date: Aug. 4, 2016

(54) MULTIPLE STRIP ARMORING SYSTEM

(71) Applicant: BARTELL MACHINERY SYSTEMS, L.L.C., ROME, NY (US)

(72) Inventors: John Patrick Harrington, Brampton (CA); Rodney Joseph Willson, Ava, NY (US)

(73) Assignee: BARTELL MACHINERY SYSTEMS, L.L.C., ROME, NY (US)

(21) Appl. No.: 15/013,403

(22) Filed: Feb. 2, 2016

Related U.S. Application Data
(60) Provisional application No. 62/111,894, filed on Feb. 4, 2015.

(51) Int. Cl. H01B 13/26

(52) U.S. Cl. CPC H01B 13/26

(57) ABSTRACT

The present embodiments are directed to an armoring system comprising at least first and second strips. In one embodiment, a forming roll comprises first and second roll segments disposed adjacent to one another. Both the first and second strips are formed into modified shapes by the forming roll. The first and second strips are helically wound into a formed tube after passing through the forming roll.

### PRIORITY CLAIM

This invention claims the benefit of priority of U.S. Provisional Application Ser. No. 62/111,894, entitled “Multiple Strip Armoring System,” filed Feb. 4, 2015, the disclosure of which is hereby incorporated by reference in its entirety.

### BACKGROUND

The present embodiments generally relate to an armoring system, which may be used to form tubular members, including but not limited to those being part of armored cables.

Armored cable is a type of cable including an inner transmission media or series of wires, which are generally enclosed by an outer armor sheath. Armored cable may be desirable in applications requiring a relatively high degree of outer protection of the inner transmission media or wires.

Armored cable may be fabricated by helically winding a strip circumferentially about one or more wires. One technique involves passing the one or more wires through a rotating coil holding a spool of the strip. As the coil rotates, the strip is then drawn from the coil, and may pass through a series of forming rollers to impart a desired shape to the strip. The strip is then circumferentially wound around the one or more wires to complete the armored cable formation.

Typically, a single strip of armored material is wound about the one or more wires. The production rate, i.e., the rate at which the armored material can successfully cover the one or more wires, is generally limited based on the rotation speed of the equipment. In other words, faster rotational winding of the single strip is a primary technique for increasing production time of the armored layer. However, there are limits on rotational speed of equipment and issues that might arise if the speed is increased too greatly, thus maintaining a limit on the production rate.

Further, in systems where more than one strip is provided as part of an armoring layer, multiple sets of tooling heads and multiple sets of forming rolls and complex guiding elements have been required. In such systems, there is a relatively large number of moving parts, adding to complexity and costs of the systems.

### SUMMARY

The present embodiments are directed to an armoring system comprising at least first and second strips. In one embodiment, a forming roll comprises first and second roll segments disposed adjacent to one another. Both the first and second strips are formed into modified shapes by the forming roll. The first and second strips are helically wound into a formed tube after passing through the forming roll.

First and second guide rollers may be disposed upstream of the forming roll, such that the first strip passes over the first guide roller and the second strip passes over the second guide roller prior to being fed towards the forming roll. The first and second roll segments of the forming roll may be disposed radially inward relative to the first and second guide rollers. In one example, the first strip passes over the first guide roller at a location longitudinally offset from a location at which the second strip passes over the second guide roller. The system may further comprise a mounting plate, and each of the first and second guide rollers, and the first and second roll segments of the forming roll, is coupled to the mounting plate.

In one embodiment, the first and second roll segments of the forming roll are disposed adjacent to one another such that a front portion of the first roll segment is disposed adjacent to a front portion of the second roll segment, and a rear portion of the first roll segment is disposed adjacent to a rear portion of the second roll segment. The front portion of the first roll segment may comprise a diameter greater than the rear portion of the first roll segment, and the front portion of the second roll segment may comprise a diameter less than the rear portion of the second roll segment. In one example, the front portion of the first roll segment spans a length along a longitudinal axis that is less than a length spanned by the rear portion of the first roll segment, and the front portion of the second roll segment spans a length along the longitudinal axis that is greater than a length spanned by the rear portion of the second roll segment.

The system may comprise a main frame having front and rear portions. The first strip may be provided from a first pack mounted near the front portion of the main frame and the second strip may be provided from a second pack mounted near the rear portion of the main frame. In one example, the first and second strips at least partially overlap with one another during passage through the forming roll and as part of the formed tube.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a side view of a first embodiment of an armoring system.

FIG. 2 is an elevated perspective view of a portion of the armoring system of FIG. 1.

FIGS. 3-5 are, respectively, perspective, front and side views depicting features of an exemplary forming roll of the armoring system of FIGS. 1-2, with select components shown in FIGS. 1-2 being omitted for clarity in FIGS. 3-5.

FIG. 6 is a sectional view, generally in a direction from above to below, of an exemplary relationship of first and second strips passing through a forming roll, with select components shown in FIGS. 1-2 being omitted for clarity in FIG. 6.

FIG. 7 is a perspective view of components of an alternative armoring system.

### DETAILED DESCRIPTION OF THE PREFERRED EMBODIMENTS

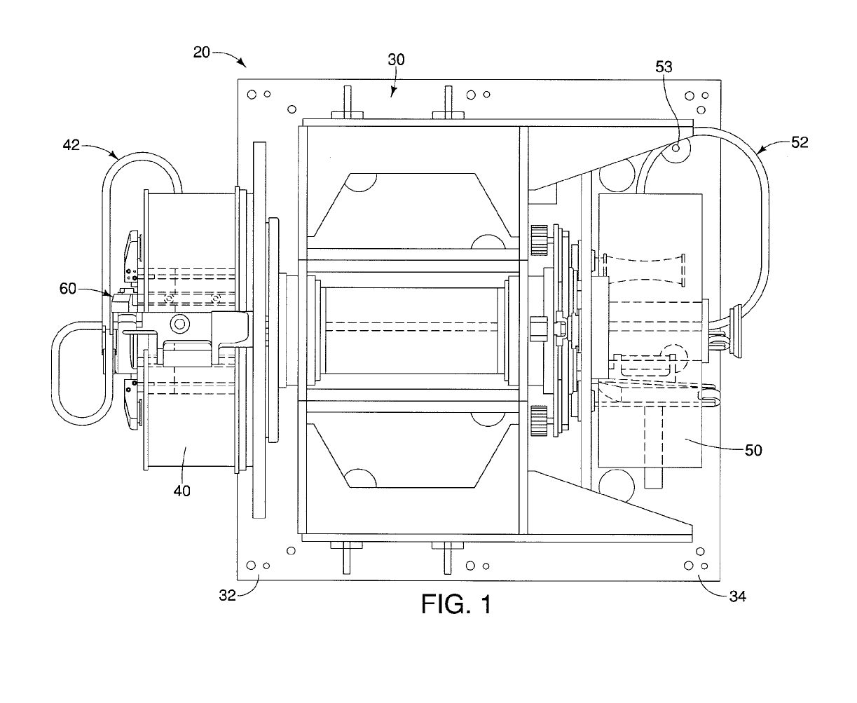

Referring to FIGS. 1-6, a first embodiment of an armoring system 20 is shown and described. The armoring system 20 may be used to form a generally cylindrical tube of material, and may be used, by way of example and without limitation, to form armored cable in which an armored layer surrounds one or more inner wires.

The armoring system 20 comprises a main frame 30 having front and rear portions 32 and 34, respectively. A first pack 40 comprising a first strip of material 42 is mounted near the front portion 32, and a second pack 50 comprising a second strip of material 52 is mounted near the rear portion 34, as generally depicted in FIG. 1. While the first pack 40 is shown extending outside of the front boundary of the main frame 30, and the second pack 50 is shown housed within the rear boundary of the main frame 30, it should be understood that one or both of the first and second packs 40 and 50 may be positioned partially or fully within the boundaries of the main frame 30 or entirely outside of the main frame 30.

The first and second packs 40 and 50 generally comprise cylindrically mounted packs housing the first and second strips 42 and 52, respectively, such that the first and second strips 42 and 52 are disposed in a coil-shaped manner around their respective first and second packs 40 and 50. Rotational movement is imparted to unwind the first and second strips 42 and 52 from their respective first and second packs 40 and 50. Upon unwinding, both the first and second strips of material 42 and 52 are routed towards a forming area 60 located near the front of the system, as will be explained further below.

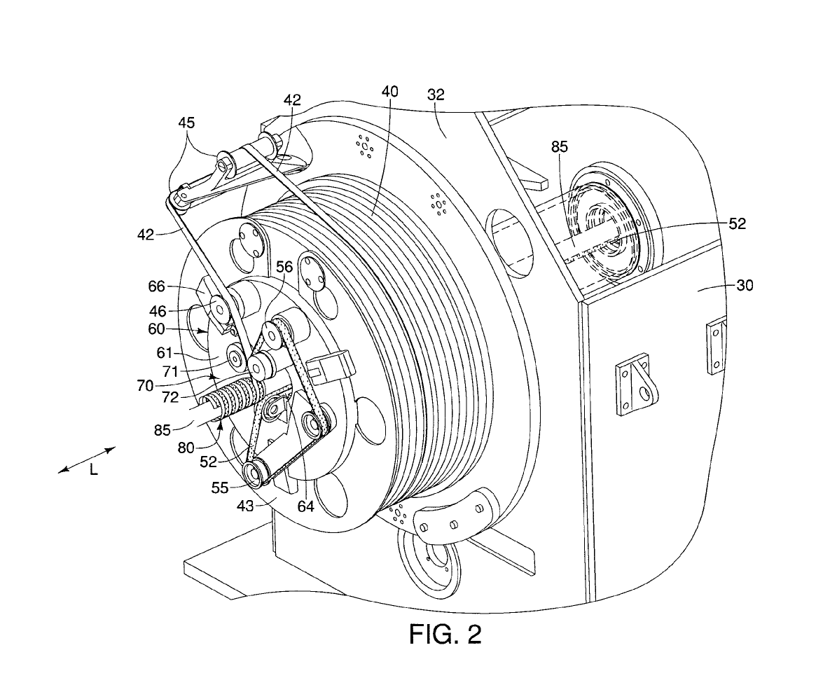

The first strip 42 may be directed around at least one guiding member towards the forming area 60. In one embodiment, the first strip 42 is directed around a plurality of intermediate rollers 45 and towards a guide roller 46, as best seen in FIG. 2.

Similarly, the second strip 52 may be directed around at least one guiding member towards the forming area 60. In the example of FIGS. 1-2, the second strip 52 is directed around an initial roller 53 (shown in FIG. 1), and then through a central region of the main frame 30, as shown in FIGS. 1-2. At this point, the second strip 52 may be directed generally along a main longitudinal axis L of the armoring system 20, and may be adjacent to a mandrel 85, as best seen in FIG. 2, where the mandrel 85 may comprise a central elongate segment of a solid material or the one or more wires to be covered by the armored sheath. The second strip 52 then may extend axially through a central region of the first pack 40, and may emerge in front of the first pack 40 as shown in FIG. 2. The second strip 52 then may be guided around a plurality of intermediate rollers 55 and towards a guide roller 56, as depicted in FIG. 2. In this manner, both the first strip 42 and the second strip 52 are guided towards a similar location on the frontal side of the first pack 40.

While exemplary paths for travel of the first and second strips 42 and 52 are depicted in FIGS. 1-2, it should be understood that these particular paths are non-limiting examples. For example, the number and placement of rollers 45 and 55 may be adjusted, as needed, to facilitate travel of the first and second strips 42 and 52 towards the forming area 60. Further, in other examples, the second strip 52 need not travel along the main longitudinal axis L of the armoring system 20, as depicted in FIG. 2, but rather may travel along a radially offset pathway spaced-apart from the main longitudinal axis L.

The forming area 60 generally comprises a mounting surface 61, which in this example comprises a generally cylindrical body to which multiple parts are secured. The mounting surface 61 comprises a central bore 64 through which the mandrel 85 is axially disposed, as depicted in FIG. 2. The mounting surface 61 may be secured to a frontal surface of a pack holder 43, as depicted in FIG. 2, using one or more coupling members 66. In the example shown, three coupling member 66 are used to secure the mounting surface 61 to the pack holder 43, although greater or fewer coupling members 66 may be used.

In one embodiment, the guide rollers 46 and 56 may be secured to an outer peripheral area of the mounting surface 61, as depicted in FIG. 2. Further, a forming roll 70 comprising first and second roll segments 71 and 72 may be secured to the mounting surface 61.

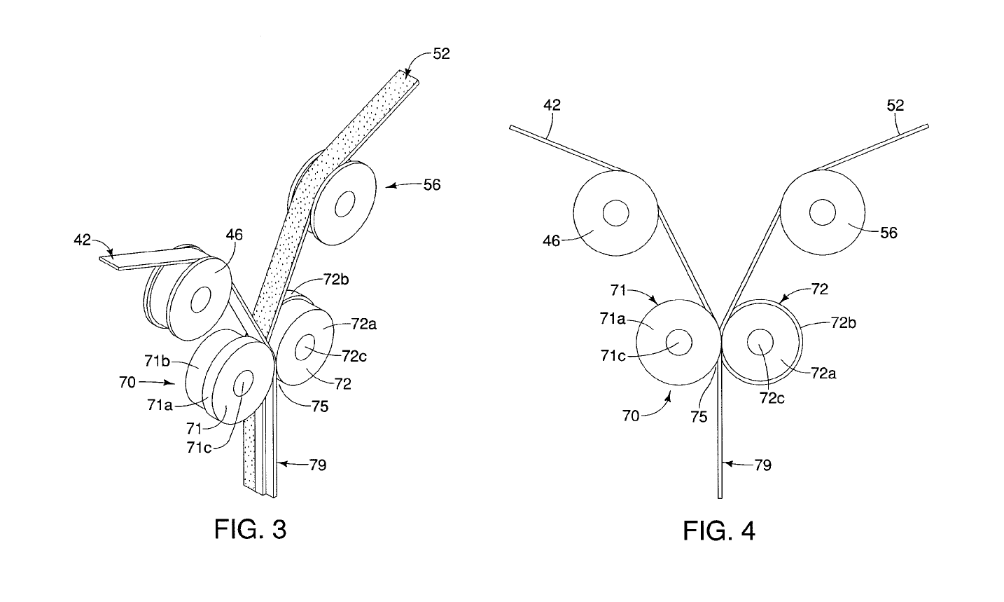

In one example, the first and second roll segments 71 and 72 of the forming roll 70 are positioned radially inward, i.e., closer to the central bore 64 of the mounting surface 61, compared to the guide rollers 46 and 56, as seen in FIG. 2. The first roll segment 71 may be disposed closer to the guide roller 46 instead of the guide roller 56, while the second roll segment 72 may be disposed closer to the guide roller 56 instead of the guide roller 46. The first and second roll segments 71 and 72 are rotatable around axes 71c and 72c, respectively, as shown in FIGS. 3, 4 and 6.

During operation, the first strip 42 travels in a direction from the guide roller 46 towards the first roll segment 71 of the forming roll 70, and may engage the first roll segment 71 for a relatively short circumferential distance, and then travel in a space 75 formed between the first and second roll segments 71 and 72 of the forming roll 70, as depicted in FIGS. 2-5. Similarly, the second strip 52 travels in a direction from the guide roller 56 towards the second roll segment 72 of the forming roll 70, and may engage the second roll segment 72 for a relatively short circumferential distance, and then travel in the space 75 formed between the first and second roll segments 71 and 72 of the forming roll 70, as depicted in FIGS. 2-5.

The first and second strips 42 and 52 may be axially offset at the time of entry into the space 75 between the first and second roll segments 71 and 72 of the forming roll 70. In one embodiment, the guide roller 46 that directs the first strip 42 may extend further away from the mounting surface 61 along the longitudinal axis L relative to the guide roller 56, such that the guide roller 56 and its associated second strip 52 are guided more closely to the mounting surface 61 along the longitudinal axis L, as depicted in FIGS. 2, 3 and 5.

In this manner, the first and second strips 42 and 52 may be longitudinally offset from one another as they are directed into the forming roll 70. In one embodiment, the first and second strips 42 and 52 may partially overlap with one another. For example, approximately one-half of the width of the first strip 42 may overlap with the second strip 52 upon entry into the forming roll 70, and this overlap may be maintained along the longitudinal length of a formed tube 80 after passing through the forming roll 70. It will be understood that the longitudinal offset of one strip relative to the other strip may be significantly more or less than half of its width. In some embodiments, the first and second strips 42 and 22 may be merely axially adjacent to one another, i.e., not longitudinally overlapping with one another. Such offset adjustments may be made by varying the extension of the respective guide rollers 46 and 56 away from the mounting surface 61, thereby varying the entry position of the respective strips 42 and 52 into the forming roll 70.

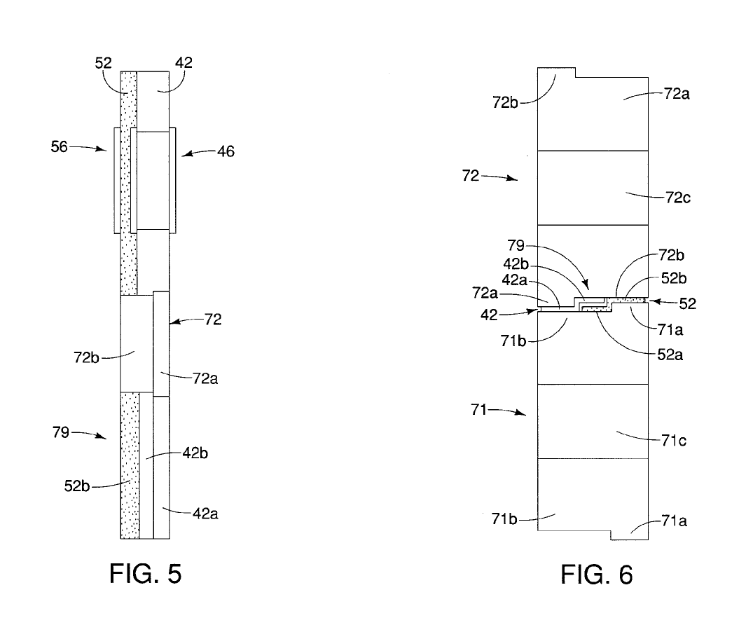

In one embodiment, the first and second roll segments 71 and 72 of the forming roll 70 may each comprise varying diameter portions. For example, the first roll segment 71 may comprise a front portion 71a having a first diameter that is larger than a second diameter of a rear portion 71b, as best seen in FIGS. 3 and 6. The second roll segment 72 may comprise a front portion 72a having a third diameter that is larger than a fourth diameter of a rear portion 72b, as best seen in FIGS. 3-6. In one embodiment, the first diameter of the front portion 71a of the first roll segment 71 is approximately equal to the fourth diameter of the rear portion 72b of the second roll segment 72, while the second diameter of the rear portion 71b of the first roll segment 71 is approximately equal to the third diameter of the front portion 72a of the second roll segment 72, as depicted in FIGS. 3, 4 and 6.

Further, the front portion 71a of the first roll segment 71 may span a length (along the longitudinal axis L) that is less than a length spanned by the rear portion 71b, while the front portion 72a of the second roll segment 72 may span a length (along the longitudinal axis L) that is greater than a length spanned by the rear portion 72b, as shown in FIGS. 3 and 6. In this manner, the relatively large diameter of the front portion 71a is adjacent to the relatively small diameter of the front portion 72a, while the relatively large diameter of the rear portion 72b is adjacent to the relatively small diameter of the rear portion 71b, and there is a longitudinal spacing between the larger diameter portions 71a and 72b, as depicted in FIGS. 2, 3 and 6.

Accordingly, based on the arrangement and configuration of the first and second roll segments 71 and 72 of the forming roll 70, the first and second strips 42 and 52 pass through the forming roll 70 to form a multiple strip segment 79. Along the multiple strip segment 79, the first strip 42 and the second strip 52 may be disposed in an adjacent or interlocking relationship. In one example, the first strip 42 is formed to have a first portion 42a spaced apart from a second portion 42b, as best seen in FIG. 6. Similarly, the second strip 52 is formed to have a first portion 52a spaced apart from a second portion 52b. The second portion 42b of the first strip 42 may surround to the first portion 52a of the second strip 52, as shown in FIG. 6.

The multiple strip segment 79 may then be wound in a helical manner to create a formed tube 80, which is formed along the longitudinal axis L, in a direction away from the mounting surface 61, as depicted in FIG. 2. Optionally, a bending member may be provided at a location downstream of the forming roll 70 to impart a curled shape upon the multiple strip segment 79 to facilitate its formation into the formed tube 80. Preferably, the multiple strip segment 79 is wound about itself, such that the cross-sectional interlocking pattern (among the various portions 42a, 42b, 52a and 52b as shown in FIG. 6) is repeated as the multiple strip segment 79 extends away from the forming roll 70 and the formed tube 80 is created.

Advantageously, the armoring system 20 simultaneously forms multiple strips 42 and 52 into a single formed tube 80, thereby increasing the production time of the formed tube 80 for any given rotational speed of the components, as compared to using a single strip to form the tube at the same rotational speed. In other words, the multiple strips 42 and 52 create more longitudinal coverage, simultaneously, as compared to a single strip being wound at the same speed.

As another advantage, the armoring system 20 utilizes a single tooling head and single forming roll set that simultaneously forms multiple strips and presents them into a final formed tube 80. This reduces the number of moving parts, complexity and costs, as compared to approaches using multiple sets of forming rolls to handle multiple different strips.

As yet a further advantage, the provision of individually mounted first and second packs 40 and 50 will allow for strip speed variations, for example, due to manufacturing imperfections. Particular advantages may be achieved by having two individually mounted packs 40 and 50, in combination with a single forming roll 70.

It will be understood that while the exemplary formed tube 80 is shown being made of two strips 42 and 52, the formed tube 80 alternatively may comprise three or more strips of material. In such embodiments, similar principles may apply as to when two strips are used (as described above), yet the third strip (or additional strips) may be guided in a direction towards the forming roll 70 via appropriate rollers, and the forming roll 70 may comprise an additional segment (similar to segments 71 and 72) that allows formation of the three or more strips simultaneously. It will also be understood the strips may be formed of a suitable material, including but not limited to stainless steel, aluminum, galvanized coated steel, or other materials, depending on the application.

The formed tube 80 may be used in an array of applications. By way of example, and without limitation, the formed tube 80 may surround one or more wires. In such instance, the one or more wires may run axially (around where the mandrel 85 is shown), and the formed tube 80 may be disposed over the one or more wires to create the armored cable. In other applications, the formed tube 80 may be formed around the mandrel 85 (without wires therein during formation), and wires then optionally may be advanced through the formed tube 80. The one or more wires used with the formed tube 80 may comprise a single strand, multiple strands, and optionally may be covered with suitable insulation.

It will be appreciated that other structures may be provided with the armoring system 20. By way of example, one or more string up clamps may be provided to engage cut ends of the strips 42 and 52, e.g., if the strips are cut for changeover or any other circumstance. Further, one or more clamps near the coil packs may prevent the strips from backing through the rollers and preventing the material from loosening on the coil pack, which results in a safety risk. Additionally, to allow for improved feeding into the forming roll 70, a straightening roller assembly may be used to unwind the material from the coil packs.

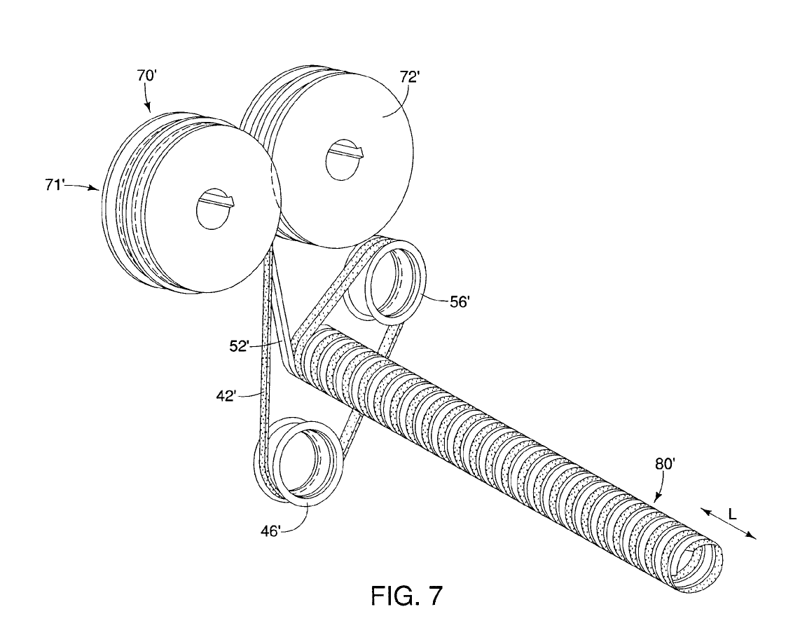

Referring to FIG. 7, a perspective view of a portion of an alternative armoring system is shown. In general, this alternative system may comprise the main frame 30, and the first and second packs 40 and 50, described above with reference to FIGS. 1-2. However, in the embodiment of FIG. 7, an alternative forming roll 70′ is positioned upstream of guide rollers 46′ and 56′. In this embodiment, strips 42′ and 52′ pass through the forming roll 70′ in a manner similar to passage through the forming roll 70 above. In the embodiment of FIG. 7, the strips 42′ and 52′ may be spaced apart to lack overlap within the forming roll 70′, i.e., the strips 42′ and 52′ are simultaneously formed by the same forming roll 70′ but at spaced apart locations. The strips 42′ and 52′ then are directed such that the strip 42′ extends around the guide roller 46′ and the strip 52′ extends around the guide roller 56′. The guide rollers 46′ and 56′ are positioned such that they direct the respective strips 42′ and 52′ towards a central longitudinal axis (or central mandrel), at which point the strips 42′ and 52′ may be disposed adjacent to one another, or overlapping one another, to form an alternative tube 80′. Accordingly, in this embodiment, the two strips 42 and 52 are formed separately, i.e., not overlapping within the same forming roll 70, and the overlap or adjacent positioning occurs at the location of the formed tube 80′.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. An armoring system, comprising:
at least first and second strips; and
a forming roll comprising first and second roll segments disposed adjacent to one another, wherein both the first and second strips are formed into modified shapes by the forming roll,
wherein the first and second strips are helically wound into a formed tube after passing through the forming roll.

2. The system of claim 1, wherein first and second guide rollers are disposed upstream of the forming roll, such that the first strip passes over the first guide roller and the second strip passes over the second guide roller prior to being fed towards the forming roll.

3. The system of claim 2, wherein the first and second roll segments of the forming roll are disposed radially inward relative to the first and second guide rollers.

4. The system of claim 2, wherein the first strip passes over the first guide roller at a location longitudinally offset from a location at which the second strip passes over the second guide roller.

5. The system of claim 2 further comprising a mounting plate, wherein each of the first and second guide rollers, and the first and second roll segments of the forming roll, is coupled to the mounting plate.

6. The system of claim 1, wherein first and second guide rollers are disposed downstream of the forming roll, such that the first strip passes over the first guide roller and the second strip passes over the second guide roller after being fed through the forming roll.

7. The system of claim 1, wherein the first and second roll segments of the forming roll are disposed adjacent to one another such that a front portion of the first roll segment is disposed adjacent to a front portion of the second roll segment, and a rear portion of the first roll segment is disposed adjacent to a rear portion of the second roll segment.

8. The system of claim 7, wherein the front portion of the first roll segment comprises a diameter greater than the rear portion of the first roll segment, and wherein the front portion of the second roll segment comprises a diameter less than the rear portion of the second roll segment.

9. The system of claim 7, wherein the front portion of the first roll segment spans a length along a longitudinal axis that is less than a length spanned by the rear portion of the first roll segment, and wherein the front portion of the second roll segment spans a length along the longitudinal axis that is greater than a length spanned by the rear portion of the second roll segment.

10. The system of claim 1 further comprising a main frame having front and rear portions, wherein the first strip is provided from a first pack mounted near the front portion of the main frame and the second strip is provided from a second pack mounted near the rear portion of the main frame.

11. The system of claim 1, wherein the first and second strips at least partially overlap with one another during passage through the forming roll and as part of the formed tube.

12. An armoring system, comprising:
at least first and second strips; and
a forming roll comprising first and second roll segments disposed adjacent to one another such that a front portion of the first roll segment is disposed adjacent to a front portion of the second roll segment, and a rear portion of the first roll segment is disposed adjacent to a rear portion of the second roll segment,
wherein the front portion of the first roll segment comprises a diameter greater than the rear portion of the first roll segment, and wherein the front portion of the second roll segment comprises a diameter less than the rear portion of the second roll segment,
wherein the first and second strips are helically wound into a formed tube after passing through the forming roll.

13. The system of claim 12, wherein first and second guide rollers are disposed upstream of the forming roll, such that the first strip passes over the first guide roller and the second strip passes over the second guide roller prior to being fed towards the forming roll.

14. The system of claim 13, wherein the first and second roll segments of the forming roll are disposed radially inward relative to the first and second guide rollers.

15. The system of claim 13, wherein the first strip passes over the first guide roller at a location longitudinally offset from a location at which the second strip passes over the second guide roller.

16. The system of claim 13 further comprising a mounting plate, wherein each of the first and second guide rollers, and the first and second roll segments of the forming roll, is coupled to the mounting plate.

17. The system of claim 12, wherein the front portion of the first roll segment spans a length along a longitudinal axis that is less than a length spanned by the rear portion of the first roll segment, and wherein the front portion of the second roll segment spans a length along the longitudinal axis that is greater than a length spanned by the rear portion of the second roll segment.

18. The system of claim 12, wherein the first and second strips at least partially overlap with one another during passage through the forming roll and as part of the formed tube.

19. A method for forming an armored tube, comprising:
providing at least first and second strips;
modifying shapes of the first and second strips using a forming roll comprising first and second roll segments disposed adjacent to one another; and
helically winding the first and second strips into a shape of a formed tube after passing through the forming roll.

20. The method of claim 19, wherein the first and second strips at least partially overlap with one another during passage through the forming roll and as part of the formed tube.
